(19) United States
(12) Patent Application Publication
(10) Pub. No.: US 2016/0001290 A1
(43) Pub. Date: Jan. 7, 2016

(54) APPARATUS AND METHODS FOR MAKING VESICLES

(71) Applicant: The Trustees of the University of Pennsylvania, Philadelphia, PA (US)

(72) Inventors: David Issadore, Philadelphia, PA (US); Jin A. Ko, Philadelphia, PA (US)

(73) Assignee: The Trustees of the University of Pennsylvania, Philadelphia, PA (US)

(21) Appl. No.: 14/790,083

(22) Filed: Jul. 2, 2015

Related U.S. Application Data
(60) Provisional application No. 62/020,150, filed on Jul. 2, 2014.

(51) Int. Cl. B01L 3/00; B01J 13/06

(52) U.S. Cl. CPC B01L 3/502784; B01J 13/06; B01L 2300/0681; B01L 2300/12; B01L 2300/0877; B01L 2300/165

(57) ABSTRACT

A microfluidic device includes a substrate and a microfluidic channel embedded in the substrate. The microfluidic channel includes a plurality of fluid inlets, at least one waste outlet, at least one vesicle outlet, a flow junction joining the at least one vesicle outlet and the at least one waste outlet in fluid communication, the flow junction having a fluid flow path that is orthogonal to the plane of the substrate, and at least one membrane between the at least one vesicle outlet and the at least one waste outlet configured to intercept a portion of the fluid flow path.

### CROSS-REFERENCE TO RELATED APPLICATIONS

This application claims priority to U.S. Provisional Application Ser. No. 62/020,150 entitled Apparatus and Methods for Making Vesicles filed on Jul. 2, 2014, the contents of which is incorporated fully herein by reference.

### FIELD OF THE INVENTION

This invention relates to the field of microfluidics and, more particularly, vesicles as well as devices and processes for producing vesicles.

### BACKGROUND OF THE INVENTION

The encapsulation of active cargo, such as small molecules, proteins, nucleic acids, and nanoparticles, into micro- and nano-scale hollow polymer vesicles has found great application for synthetic biology, cosmetics, and controlled drug delivery. Over the last decade, there has been progress engineering vesicles to have specific properties for particular applications, such as tuned biodegradability, molecular-specific binding, and triggered drug release.

Currently, vesicles are produced with bulk-assembly methods, such as lipid film hydration, electroformation, extrusion, and on-chip mixing. In addition to suffering from a lack of control over the vesicles' composition (such as the inner and outer leaflet of the vesicle), these techniques suffer from relatively low capture yield of the valuable cargo. One approach for fabricating vesicles is microfluidic-directed assembly in which microfluidic structures are used to translate emulsions of water-in-oil across an oil-water interface. Unfortunately, these known approaches have generally failed to mass produce vesicles on the nanometer scale due to the challenges of controlling fluids on that length scale.

### SUMMARY OF THE INVENTION

Aspects of the invention relate to vesicles, as well as devices and processes for producing vesicles.

In accordance with one aspect, the invention provides a microfluidic device for generating vesicles. The microfluidic device includes a substrate and a microfluidic channel embedded in the substrate. The microfluidic channel includes a plurality of fluid inlets, at least one waste outlet, at least one vesicle outlet, a flow junction joining the at least one vesicle outlet and the at least one waste outlet in fluid communication, the flow junction having a fluid flow path that is orthogonal to the plane of the substrate, and at least one membrane between the at least one vesicle outlet and the at least one waste outlet configured to intercept a portion of the fluid flow path.

In accordance with another aspect, the invention provides a microfluidic device for generating vesicles. The microfluidic device includes a substrate and a microfluidic channel embedded in the substrate. The microfluidic channel includes an oil inlet, an emulsion inlet, an aqueous phase inlet, a first waste outlet in fluid communication with the emulsion inlet and the oil inlet, a second waste outlet in fluid communication with the oil inlet and the aqueous phase inlet, at least one vesicle outlet, a first flow junction joining the oil inlet and the emulsion inlet in fluid communication, the first flow junction having a first flow path that is orthogonal to the plane of the substrate, a second flow junction joining the at least one vesicle outlet and the second waste outlet in fluid communication, the second flow junction having a second fluid flow path that is orthogonal to the plane of the substrate, a first membrane between the first waste outlet and the oil inlet configured to intercept a portion of first fluid flow path, and a second membrane between the second waste outlet and the vesicle outlet configured to intercept the second fluid flow path.

In accordance with yet another aspect, the invention provides a method of for producing vesicles with a microfluidic device having a microfluidic channel embedded in a substrate. The method includes the steps of supplying an emulsion flow comprising a plurality of emulsion droplets into a first fluid inlet of the microfluidic channel, supplying a liquid flow into a second fluid inlet of the microfluidic channel, combining the emulsion flow with the liquid flow in a flow junction to form a combined fluid flow, the combined fluid flow traveling orthogonal to the plane of the substrate, and, using a membrane disposed in the flow junction, transferring the plurality of emulsion droplets from the emulsion flow to the liquid flow resulting in vesicles.

In accordance with still another aspect, the invention provides a method of producing vesicles having a tunable inner leaflet and a tunable outer leaflet. The method includes the steps of supplying an emulsion flow including a plurality of emulsion droplets and a first surfactant into a first fluid inlet of a microfluidic channel of a microfluidic device embedded in a substrate, supplying an oil flow including a second surfactant into a second fluid inlet of the microfluidic channel, combining the emulsion flow with the oil flow in a first flow junction to form a first combined fluid flow, the combined fluid flow traveling orthogonal to the plane of the substrate, using a membrane disposed in the flow junction, transferring the plurality of emulsion droplets from the emulsion flow to the oil flow resulting in second emulsion flow, supplying an aqueous flow into a third fluid inlet of the microfluidic channel, combining the second emulsion flow with the aqueous flow in a second flow junction to form a second combined fluid flow, the second combined fluid flow traveling orthogonal to the plane of the substrate and, using a membrane disposed in the second flow junction, transferring the plurality of emulsion droplets from the second emulsion flow to the aqueous phase resulting in vesicles.

In accordance with another aspect, the invention provides a plurality of vesicles obtained according to any of the inventive methods.

It is to be understood that both the foregoing general description and the following detailed description are exemplary, but are not restrictive, of the invention.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1a is a schematic illustration of a microfluidic device according to aspects of the present invention;

FIG. 1b is a schematic illustration of a microfluidic device according to aspects of the present invention;

FIG. 1c is a top-view photograph of a microfluidic device having a droplet maker according to aspects of the present invention

FIG. 2a is a schematic illustration of an emulsion droplet according to aspects of the present invention;

FIG. 2b is a schematic illustration of the transfer of an emulsion droplet across an oil/water interface according to aspects of the present invention;

FIG. 2c is a schematic illustration of a vesicle according to aspects of the present invention;

FIG. 3 is a schematic illustration of a microfluidic device according to aspects of the present invention;

FIG. 4a is a schematic illustration of an emulsion droplet according to aspects of the present invention;

FIG. 4b is a schematic illustration of the transfer of an emulsion droplet across an oil/oil interface according to aspects of the present invention;

FIG. 4c is a schematic illustration of the transfer of an emulsion droplet across an oil/water interface according to aspects of the present invention;

FIG. 4d is a schematic illustration of a vesicle according to aspects of the present invention;

FIG. 5 is a flow diagram of a method for producing vesicles according to aspects of the present invention;

FIG. 6 is a flow diagram of a method for producing vesicles according to aspects of the present invention;

FIG. 7a is a fluorescence micrograph of a microscale emulsion according to aspects of the present invention;

FIG. 7b is a fluorescence micrograph of a vesicle according to aspects of the present invention;

FIG. 7c is a graph depicting mean fluorescence intensity (MFI) for to emulsion droplets and vesicles according to aspects of the present invention;

FIG. 8 is a top-view photograph of a microfluidic device according to aspects of the present invention; and

FIG. 9 is a top-view depiction of layers used to generate a microfluidic device according to aspects of the present invention.

### DETAILED DESCRIPTION OF THE INVENTION

Aspects of the invention are directed to methods for producing vesicles, vesicles produced by the inventive methods, and microfluidic devices for producing vesicles.

The inventors have recognized that it would be useful to provide for the bulk production of micro- and nano-scale vesicles using a microfluidic device. The inventors have also recognized that the use of a microfluidic device combining vertical laminar flow (i.e., flow in a direction orthogonal to the plane of the substrate) with one or more membranes enables the production of stable vesicles having tunable inner and outer leaflets. In particular, the inventors have realized that the inventive microfluidic device provides an advantage over conventional lithographically defined features and planar laminar flow (i.e., flow in the direction of the plane of the substrate). The inventors have similarly recognized that vesicles produced using the inventive methods and apparatus can achieve high capture yield (approaching 100%).

As used herein, “vesicle” refers generally to the class of micro- and nanoscopic sacs that enclose a volume within a lipid membrane.

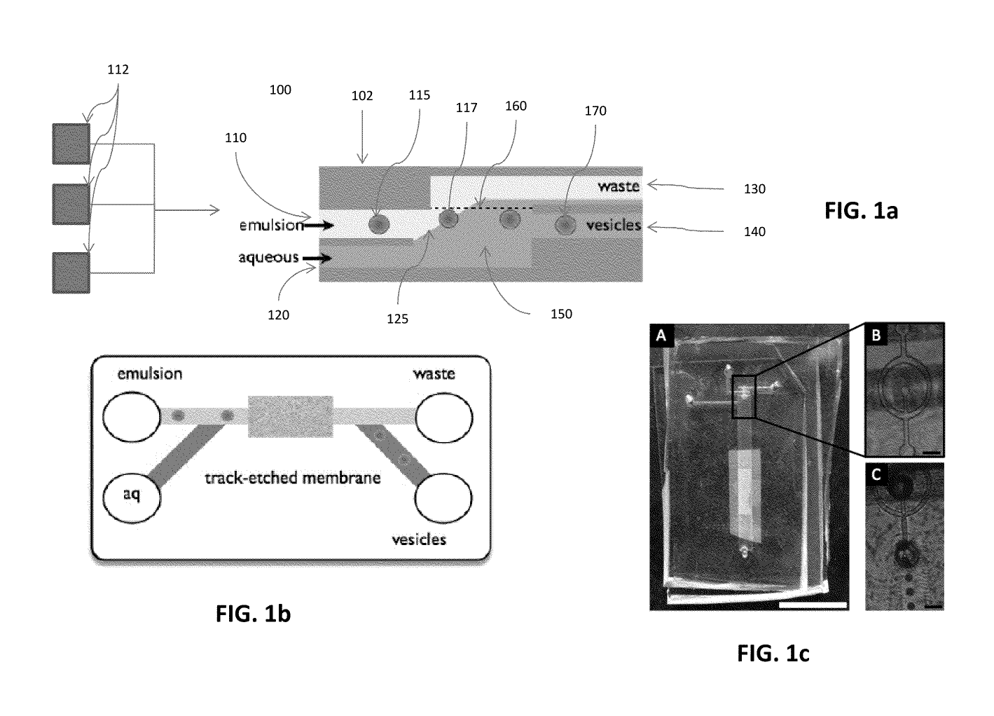

FIG. 1a shows a schematic illustration of a cross-section of a microfluidic device 100 for generating vesicles according to aspects of the present invention. The inventive microfluidic device permits the controlled assembly of both micro- and nano-vesicles and can achieve high capture yield (approaching 100%) compared to the <50% capture yield of conventional methods.

Microfluidic device 100 may be formed on a substrate. Exemplary substrates materials include glass, silica, mylar, polysiloxanes, or carbon-based polymers including, but not limited to polydimethylsiloxane (“PDMS”), a polyacrlyamide, a polyacrylate, a polymethacrylate or a mixtures thereof. One of ordinary skill in the art will understand that glass would increase the compatability of the device with solvents.

Microfluidic device 100 includes a plurality of fluid inlets embedded in a substrate 102. In the depicted embodiment, the plurality of fluid inlets includes a fluid inlet for a liquid 120, such as an aqueous phase, and a fluid inlet for an emulsion 110. Fluid inlet 120 and fluid inlet 110 are in fluid communication and may join one another at a flow junction 150. Flow junction 150 also joins vesicle outlet 140 and waste outlet 130 in fluid communication. Because each are in continuous fluid communication with each other, Fluid inlet 120, fluid inlet 110, flow junction 150, vesicle outlet 140, and waste outlet 130 may, collectively, be referred to as a “microfluidic channel.”

In an exemplary embodiment, fluid inlet 110 includes a stream of a plurality of water-in-oil emulsion droplets. Flow velocity through the microfluidic channel may be as high as 10 mm/second, although the maximum flow velocity may be determined by reference to the amount of time necessary for the surfactant to fully encapsulate the emulsion to form the outer leaflet of the vesicle (i.e., the amount of time needed by the emulsion at the oil/water interface). This time is also a function of the surfactant concentration and the diffusion rate of the surfactant. Exceeding the maximum flow velocity can result in de-stabilization of the emulsion droplets and a poor recovery of vesicles.

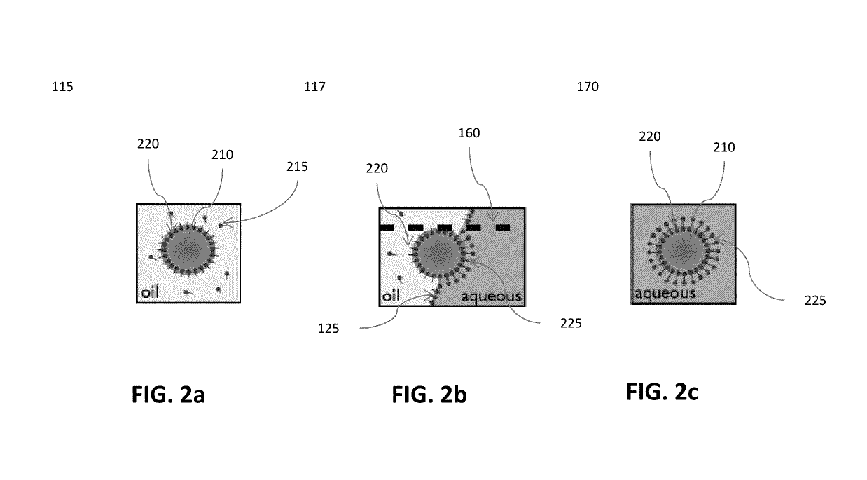

Turning briefly to FIG. 2a, a water-in-oil droplet 115 is shown. Water-in-oil droplet 115 includes an aqueous core 210. Aqueous core 210 may comprise a variety of different types of agents (which may be referred to as “cargo” or “payload”) such as, e.g., a therapeutic agent. The therapeutic agent may be, e.g., one or more small molecules, proteins, nucleic acids, nanoparticles, or mixtures thereof. Water-in-oil droplet 115 is stabilized by a surfactant 215 in the oil continuous phase. Surfactant 215 (oriented such that the hydrophilic head is oriented towards aqueous core 210) forms an inner leaflet 220 that encapsulates aqueous core 210. Surfactant 215 may desirably be any surfactants, polymers or lipids, as long as they show high solubility in oil and do not have compatibility issues with the materials used to manufacture the device (i.e. absorption).

Returning to FIG. 1a, the plurality of water-in-oil emulsion droplets 115 may be generated by one or a series of droplet makers 112. Droplet maker 112 may then feed the generated the plurality of water-in-oil emulsion droplets into fluid inlet 110. The use of droplet maker 112 may provide several benefits, including greater control over emulsion size, low size variation, and contents of the emulsion. Droplet maker 112 may be manufactured of PDMS, and may be, e.g., a flow-focused droplet maker or a T-junction droplet maker. In this regard, the microfluidic channel is shown in cross-section only; one of ordinary skill in the art will understand, however, upon reading this disclosure that the width of this channel can range from 1 μm to 10 mm to accommodate one or multiple droplet makers. One of ordinary skill in the art will understand that even greater channel widths may be employed. Increasing the width of the microfluidic channel increases the throughput, i.e., rate of production, of vesicles.

Fluid inlet 120 may include a laminar flow of an aqueous phase.

The emulsion in fluid inlet 110 and the liquid in fluid inlet 120 join together at flow junction 150. When the laminar flow of aqueous phase combines with the emulsion, the aqueous phase may redirect the emulsion upwards in a vertical flow path, i.e., a flow path orthogonal to the plane of the substrate 100 (which is shown in cross-section). In doing so, the continuous phase of the emulsion is directed through a membrane 160 and into waste outlet 130. Membrane 160 may be positioned between waste outlet 130 and vesicle outlet 140. As depicted, a portion of the aqueous phase may also be directed through membrane 160.

Membrane 160 may be a nanoporous membrane. Exemplary nanoporous membranes include ion track-etched nanoporous polycarbonate membranes, silicon on insulator (SOI) arrays, and silicon or silicon nitride membranes processed using lithography and semiconductor etching techniques. Unlike conventional lithography, polycarbonate membranes can be fabricated with well defined nanoscale feature sizes over large areas (A>10 cm²). Suitable ion track-etched nanoporous polycarbonate membranes include those having a pore diameter ranging from 15 nm to 30 μm and a pore density ranging from 10⁵-10⁸ pores/cm², depending on the particular pore diameter.

Membrane 160 is preferably hydrophobic. In addition to the pore diameter limitation, this hydrophobicity permits the continuous phase of the emulsion to pass through the membrane while deflecting the water-in-oil emulsion droplets away from waste outlet 130.

Water-in-oil emulsion droplet 117 is deflected by membrane 160 across oil/water interface 125. Turning briefly to FIG. 2b, surfactants 215 reside at oil/water interface 125. During the transfer of water-in-oil emulsion droplet 117 across oil/water interface 125, surfactants 215 begin to form an outer leaflet 225. Returning to FIG. 1a, membrane 160 continues to deflect the water-in-oil emulsion droplets, causing a transfer of water-in-oil emulsion droplets from the continuous phase of the emulsion into the aqueous phase. Upon transfer from the continuous phase of the emulsion into the aqueous phase, vesicles 170 are completed. Vesicles 170 are unilamellar, i.e., the vesicles include only one phospholipid bilayer. FIG. 2c depicts vesicles 170 fully encapsulated by inner leaflet 220 and outer leaflet 225. Vesicles 170 flow into vesicle outlet 140 for subsequent collection.

FIG. 1b is a simplified schematic of microfluidic device 100 from a top-down perspective.

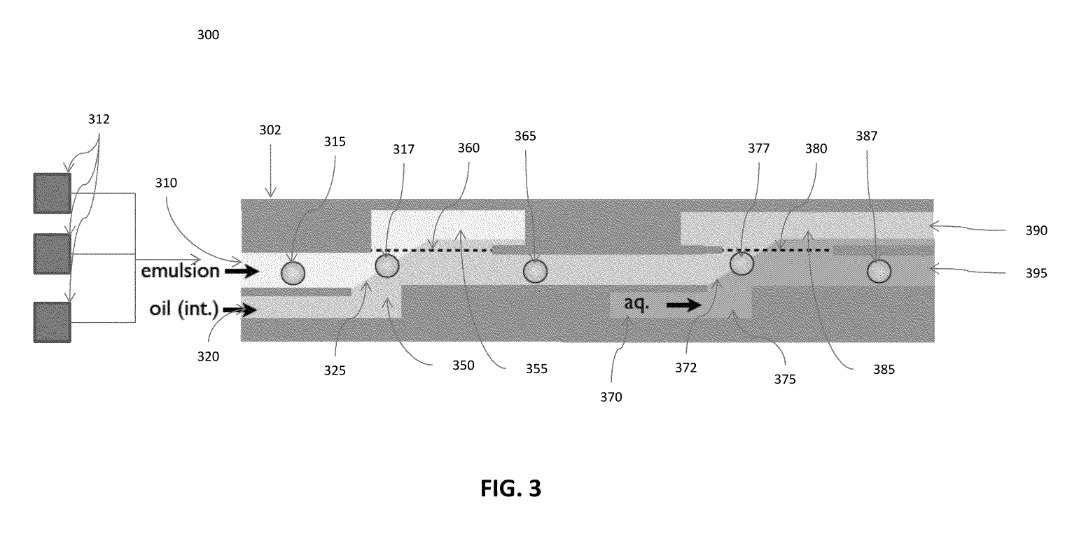

FIG. 3 depicts a microfluidic device 300 for generating vesicles according to the present invention. In particular, microfluidic device 300 permits tunable mass production of vesicles, i.e., it allows for mass production of vesicles while still permitting independent control over the type(s) of surfactants used to form the inner leaflet and the outer leaflet of the vesicle. FIG. 3 operates similar to microfluidic device 100, but includes an additional stage.

Microfluidic device 300 includes a plurality of fluid inlets embedded in a substrate 302. In the depicted embodiment, the plurality of fluid inlets includes a fluid inlet for a first emulsion 310, a fluid inlet for an oil 320, and a fluid inlet for an aqueous phase 370.

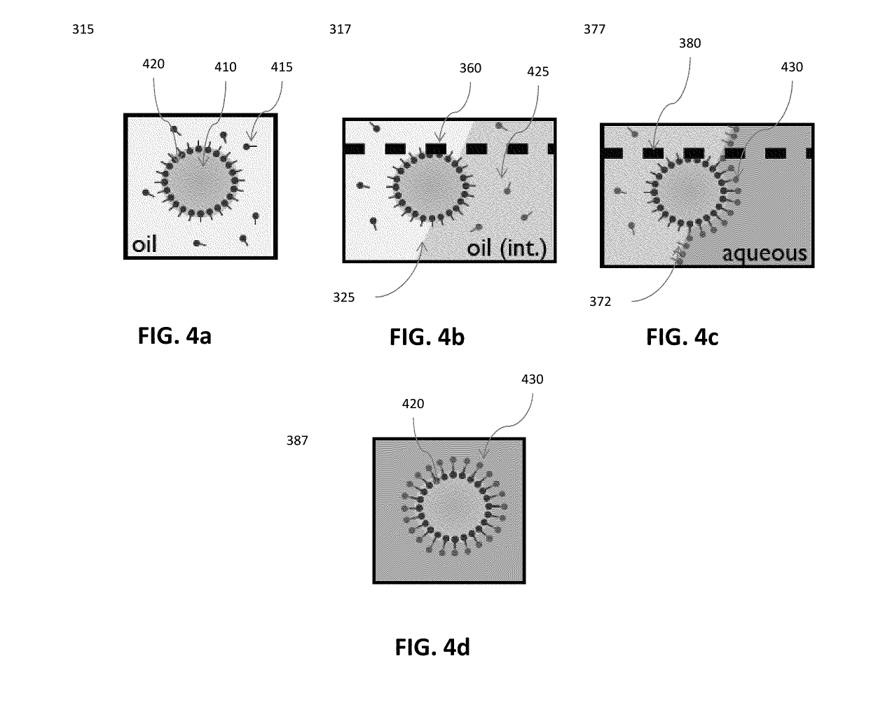

Fluid inlet 310 includes a stream of a plurality of water-in-oil emulsion droplets. Turning briefly to FIG. 4a, a water-in-oil droplet 315 is shown. Water-in-oil droplet 315 includes an aqueous core 410. Water-in-oil droplet 315 is stabilized by a first surfactant 415 in the oil continuous phase. Surfactant 415 forms an inner leaflet 420 that encapsulates aqueous core 410.

Fluid inlet 320 may include a laminar flow of an oil. Suitable oils include any oil in which the surfactant may be dissolved. The oil of fluid inlet 320 may also include a second surfactant 425, as shown in FIG. 4b. First surfactant 415 and second surfactant 425 may be the same or they may be different. The ability to independently control the identity of first surfactant 415 and second surfactant 425 permits mass production of vesicles having tunable inner and outer leaflets.

Fluid inlet 370 may include a laminar flow of an aqueous phase.

Returning to FIG. 3, the plurality of water-in-oil emulsion droplets may be generated by one or a series of droplet makers 312. Droplet maker 312 may then feed the generated the plurality of water-in-oil emulsion droplets into fluid inlet 310.

The emulsion in fluid inlet 310 and the oil in fluid inlet 320 join together at a first flow junction 350. When the laminar flow of oil from fluid inlet 320 combines with the first emulsion from fluid inlet 310, the oil may redirect the first emulsion upwards in a vertical flow path, i.e., a flow path orthogonal to the plane of the substrate 302 (which is shown in cross-section). In doing so, the continuous phase of the emulsion is directed through a first membrane 360 and into a first waste outlet 355. First membrane 360 may be positioned between first waste outlet 355 and the other portions of the microfluidic channel. As depicted, a portion of the oil from fluid inlet 320 may also be directed through membrane 360.

Water-in-oil emulsion droplet 317 is deflected by membrane 360 across oil/first emulsion interface 325. FIG. 4b depicts water-in-oil emulsion droplet 317 at oil/first emulsion interface 325, where first surfactant 415 and second surfactant 425 reside on different sides of interface 325. Membrane 360 continues to deflect the water-in-oil emulsion droplets, causing a transfer of water-in-oil emulsion droplets from the first emulsion into the oil resulting in a second emulsion.

Water-in-oil emulsion droplet 365 is shown in the second emulsion in planar flow towards an oil/water interface 372. When the laminar flow of aqueous phase from fluid inlet 370 combines with the second emulsion at the second flow junction 375, the aqueous phase may redirect the second emulsion upwards through second flow junction 375 in a vertical flow path, i.e., a flow path orthogonal to the plane of the substrate 302. In doing so, the continuous phase of the second emulsion is directed through a membrane 380 and into a second waste outlet 390. Membrane 380 may be positioned between second waste outlet 390 and vesicle outlet 395. As depicted, a portion of the aqueous phase may also be directed through membrane 380.

Water-in-oil emulsion droplet 377 is deflected by a second membrane 380 across oil/water interface 372. Turning briefly to FIG. 4c, second surfactants 425 reside at oil/water interface 372. During the transfer of water-in-oil emulsion droplet 377 across oil/water interface 372, second surfactants 425 begin to form an outer leaflet 430. Returning to FIG. 3, membrane 380 continues to deflect the water-in-oil emulsion droplets, causing a transfer of water-in-oil emulsion droplets from the continuous phase of the second emulsion into the aqueous phase. Upon transfer from the continuous phase of the second emulsion into the aqueous phase, vesicles 387 are completed. FIG. 4d depicts vesicles 387 fully encapsulated by inner leaflet 420 and outer leaflet 430. Returning to FIG. 3, vesicles 387 flow into vesicle outlet 395 for subsequent collection.

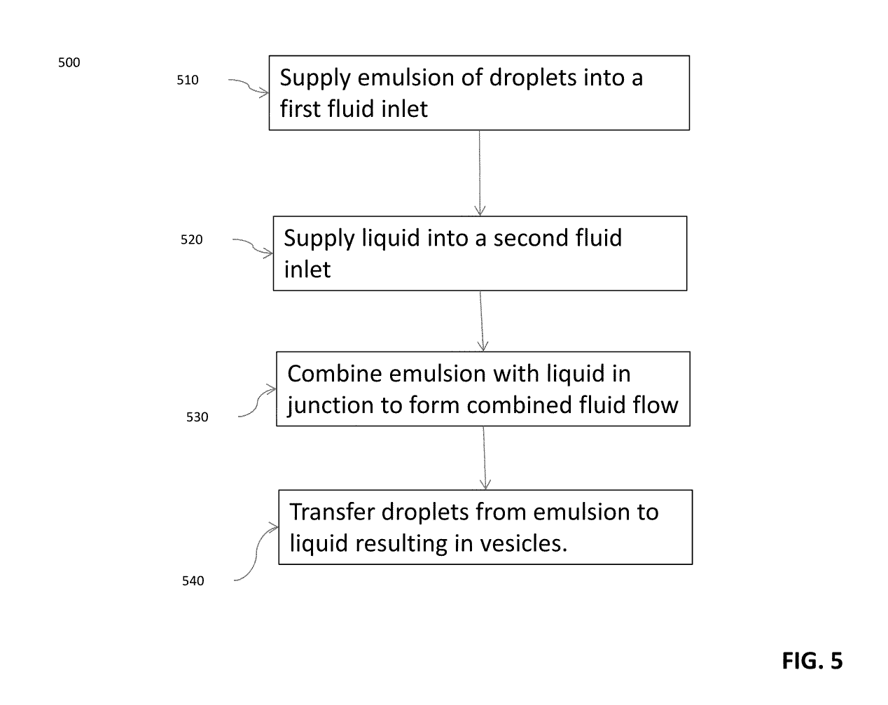

Turning to FIG. 5, a flow diagram depicting selected steps of a process 500 for producing vesicles using a microfluidic device having a microfluidic channel embedded in a substrate according to aspects of the invention is shown. It should be noted that, with respect to the methods described herein, it will be understood from the description herein that one or more steps may be omitted and/or performed out of the described sequence of the method (including simultaneously) while still achieving the desired result.

In step 510, an emulsion flow including a plurality of emulsion droplets is supplied into a first fluid inlet of the microfluidic channel (e.g. fluid inlet 110; FIG. 1). The plurality of emulsion droplets may be generated by, e.g., one or a series of droplet makers 112. The emulsion flow may be a water-in-oil emulsion. The water-in-oil emulsion may be stabilized by one or more surfactants.

In step 520, a liquid flow is supplied into a second fluid inlet of the microfluidic channel (e.g. fluid inlet 120; FIG. 1). The liquid flow may be a laminar flow of an aqueous phase.

In step 530, the emulsion flow is combined with the liquid flow in a flow junction(e.g. flow junction 150; FIG. 1) to form a combined fluid flow. In the flow junction, the combined fluid flow travels orthogonal to the plane of the substrate.

In step 540, a membrane (e.g. membrane 160; FIG. 1) disposed in the flow junction transfers the plurality of emulsion droplets from the emulsion flow to the liquid flow resulting in the generation of vesicles. The membrane further deflects the vesicles into a vesicle outlet (e.g., vesicle outlet 140; FIG. 1) The membrane may be a nanoporous membrane as described above.

The laminar flowing aqueous phase may direct the emulsion flow into contact with the membrane. The continuous phase of the emulsion may pass through the membrane, while the hydrophobicity and pore size of the membrane cause the emulsion droplets to be deflected.

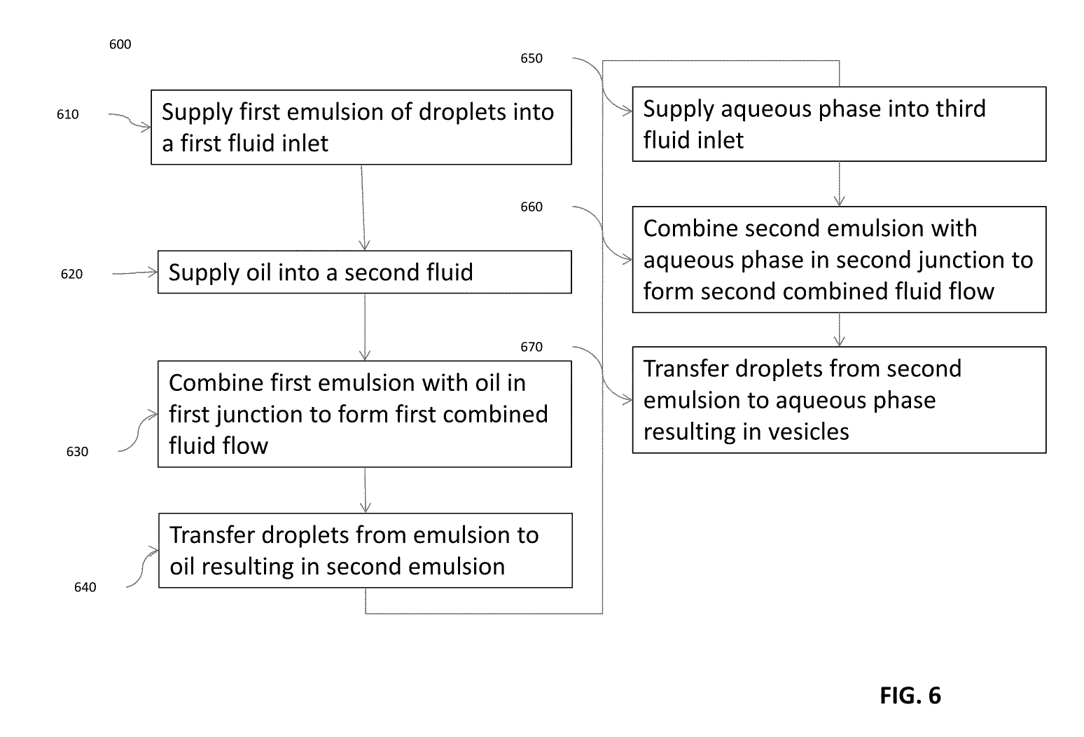

Turning to FIG. 6, a flow diagram depicting selected steps of a process 600 for producing vesicles having a tunable inner leaflet and a tunable outer leaflet according to aspects of the invention is shown.

In step 610, an emulsion flow including a plurality of emulsion droplets and a first surfactant is supplied into a first fluid inlet of a microfluidic channel (e.g. fluid inlet 310; FIG. 3) of a microfluidic device embedded in a substrate. The first surfactant may act to stabilize the plurality of emulsion droplets.

In step 620, an oil flow including a second surfactant is supplied into a second fluid inlet of the microfluidic channel (e.g. fluid inlet 320; FIG. 3). The first surfactant and the second surfactant may be the same or they may be different depending on the desired characteristics of the inner and outer leaflets respectively.

In step 630, the emulsion flow is combined with the oil flow in a first flow junction (e.g. first flow junction 350; FIG. 3) to form a first combined fluid flow. In the first flow junction, the first combined fluid flow travels orthogonal to the plane of the substrate.

In step 640, a membrane (e.g. membrane 360; FIG. 3) disposed in the first flow junction transfers the plurality of emulsion droplets from the emulsion flow to the oil flow resulting in the generation of a second emulsion.

In step 650, an aqueous flow is supplied into a third fluid inlet of the microfluidic channel (e.g. fluid inlet 370; FIG. 3).

In step 660, the second emulsion flow is combined with the aqueous flow in a second flow junction (e.g. second flow junction 375; FIG. 3) to form a second combined fluid flow. In the second flow junction, the second combined fluid flow travels orthogonal to the plane of the substrate.

In step 670, a membrane (e.g. membrane 380; FIG. 3) disposed in the second flow junction transfers the plurality of emulsion droplets from the second emulsion flow to the aqueous flow resulting in the generation of vesicles. The membrane further deflects the vesicles into a vesicle outlet (e.g., vesicle outlet 395; FIG. 3)

In accordance with other aspects, a plurality of vesicles is provided. The plurality of vesicles may be obtained from the inventive methods described herein.

### EXAMPLES

The following examples are included to demonstrate the overall nature of the present invention. The examples further illustrate the improved results obtained by generating stable monodisperse microbubbles and by employing the microfluidic device and related processes according to principles of the present invention.

### Example 1

### Manufacture of a Microfluidic Device

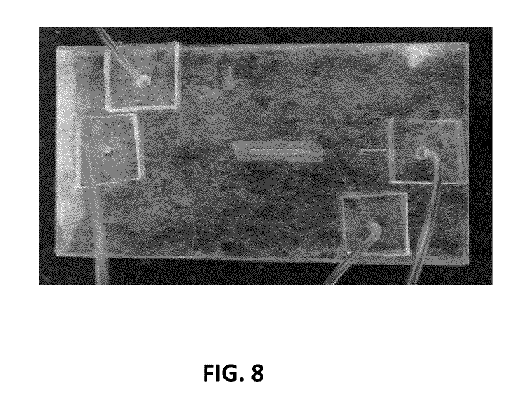

FIG. 8 depicts a microfluidic device with a d=1 μm pore size polycarbonate track-etched membrane was fabricated. The top-view photograph of the prototype device is shown (W 89 mm×H 47 mm). It consists of a membrane in the middle and a window at the end of the device for observation on chip. Two input and two output channels are connected to the tubing using PDMS ports. The top left channel is for aqueous solution, the bottom left for emulsion, top right for vesicle collection, and bottom right for waste.

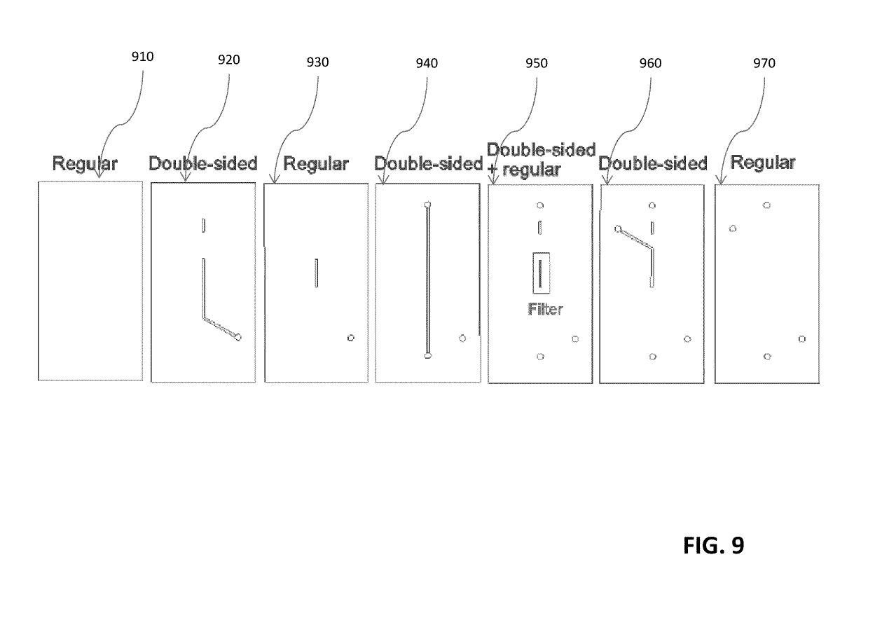

Turning to FIG. 9, an exemplary schematic of the method used to fabricate the device is shown. The micropore filter of layer 950 was integrated into a microfluidic chip using laser-cut laminate sheet microfluidics. The microfluidic channel patterns for layers 920-960 were defined using lasercutting with a VLS3, VersaLaser (Universal Laser Systems, Inc., Scottsdale, Ariz.). The layers of 100 μm thick moisture-resistant polyester (McMaster Carr, Elmhurst, Ill.) and 50 μm thick and double-sided adhesive polyester sheets (Fralock, Valencia, Calif.) were assembled to make the device. The device was connected to a syringe pump using blunt syringe tips (McMaster Carr Elmhurst, Ill.), PDMS (SYLGARD®, Dow Corning, Midland, Mich.) ports, and a tubing (Cole Parmer, Vernon Hills, Ill.). The same device may also be made using PDMS, simply stamping two pieces. As PDMS exhibits low autofluorescence, it is easier to observe and image on chip.

The device of bottom to top is arranged left to right. Layers 920, 940, and 960 are channel layers for an aqueous solution channel, emulsion and output channel, and waste channel respectively. Layers 910 and 970 (bottom and top) were made using a regular polyester material while the channel layers 920, 940, and 960 are made using a double-sided adhesive polyester. Layers 930 and 950 are made using both a regular polyester and a double-sided adhesive polyester. Layer 930 is inserted in order to separate channels and layer 950 is printed twice and used to integrate a micropore filter in between and sandwich it to prevent leakage.

An advantage of using PDMS to manufacture the device is that it enables microfluidic emulsion generators to be directly integrated onto the device. Turning to FIG. 1c, the left hand image is a top view of a micrograph of a PDMS droplet maker integrated device is shown. It consists of three PDMS layers, one molded layer and two laser-engraved layers. The polycarbonate track-etched membrane is placed between the two laser-engraved layers. The scale bar is 15 mm. The upper right hand image is a magnified image of the droplet maker with oil input channel on top and aqueous input channel in the middle and the output channel at the bottom. The scale bar is 150 μm. The bottom right hand image is the droplet maker in action imaged using a microscope. Droplets having a 60 μm diameter are generated. The scale bar is 150 μm.

### Example 2

### Sample Preparation and Operation of Microfluidic Device

Micro-scale droplets were created by adding 10 μl of 0.15 M MgSO₄ in deionized (DI) water to 1 ml of 2 mg/ml diacylglycerol (POPC) in light mineral oil (Fisher). 0.25 μM dextran-tetramethylrhodamine (Invitrogen) was used to stain the droplets. The aqueous solution was prepared by using 0.25 μM fluorescein dye (Fisher) in 0.15 M MgSO₄ in DI water. The emulsion was vortexed for few seconds to make droplets of 10-100 μm in diameter.

The prepared samples were delivered using syringe pumps with the flow rate of 0.2 ml/hr for the aqueous solution and the emulsion. The syringe pump pulled the oil from the waste channel through the filter with the flow rate of 0.3 ml/hr.

### Example 3

### Characterization

Capture efficiency in the micro-scale droplets is measured using fluorescence microscopy. The input droplets and the output vesicles were imaged with the same setting (exposure time and gain). The droplets were loaded with a rhodamine dye and the mean fluorescence intensity (MFI) of the dye encapsulated inside the droplets and vesicles was calculated. Then, the intensity of the dextrantetramethylrhodamine may be calculated using image analysis software (ImageJ). For the nano-scale vesicles, capture efficiency may be calculated using a flow-fractionation column and a fluorimeter.

The size distribution of the micro-scale vesicles and droplets will be measured using bright-field microscopy in-flow and image analysis software (ImageJ). The size distribution of the nano-scale vesicles will be measured using dynamic light scattering (Zetasizer, Malvern, Pa.).

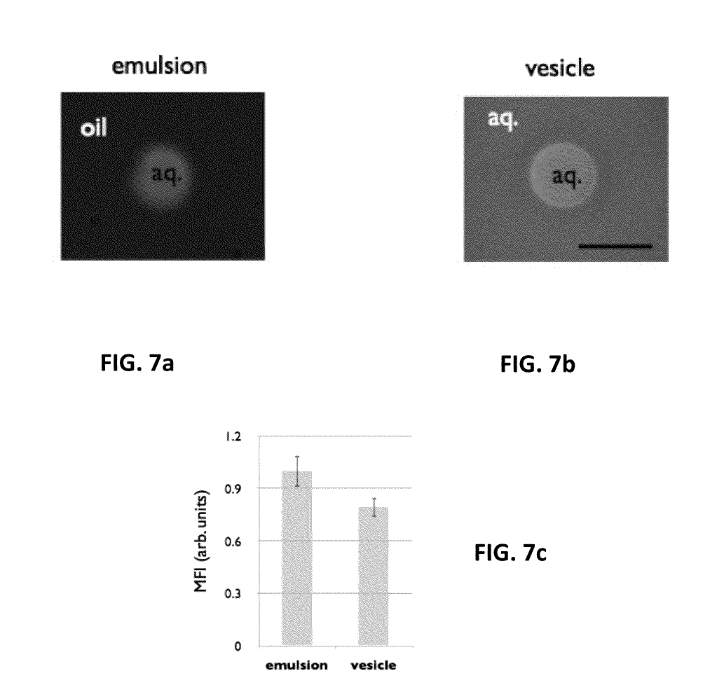

FIG. 7a is a fluorescence micrograph of a microscale emulsion of a rhodamine labeled aqueous solution in oil before being processed by the chip. FIG. 7b is a fluorescence micrograph of a unilamellar vesicle suspended in fluoroscein labeled aqueous solution after bring processed by the chip. The scale bar is 20 μm. FIG. 7c depicts the mean fluorescence intensity (MFI) calculations based on the raw intensity of the droplets/vesicles with the value was normalized by their volumes. The encapsulation efficiency was calculated based on the MFI of droplets and vesicles and 80% was achieved.

The vertical laminar flow aspect of the inventive device allows much higher throughput than previous work that utilize planar laminar flow (>100×). The large number of pores in the track-etched membranes give robust use, as the clogging of a few pores does not significantly change the behavior of the device. Additionally, because the nano-scale feature size of the inventive device comes from the inexpensive track-etching technique, the devices can be manufactured inexpensively using millimeter-scale fluidics. As various pore sizes are available for the track-etched membrane, vesicles with size of interest can be easily created while filtering out those that are unnecessary.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A microfluidic device for generating vesicles comprising:
a substrate; and
a microfluidic channel embedded in the substrate, the microfluidic channel including:
a plurality of fluid inlets;
at least one waste outlet;
at least one vesicle outlet;
to a flow junction joining the at least one vesicle outlet and the at least one waste outlet in fluid communication, the flow junction having a fluid flow path that is orthogonal to the plane of the substrate; and
at least one membrane between the at least one vesicle outlet and the at least one waste outlet configured to intercept a portion of the fluid flow path.

2. The microfluidic device of claim 1, wherein the substrate is comprised of a polymer.

3. The microfluidic device of claim 2, wherein the substrate is comprised of polydimethylsiloxane.

4. The microfluidic device of claim 1, wherein the plurality of fluid inlets comprises a fluid inlet for a liquid and a fluid inlet for an emulsion.

5. The microfluidic device of claim 4, wherein the emulsion comprises a plurality of water-in-oil emulsion droplets.

6. The microfluidic device of claim 4 further comprising at least one emulsion droplet generator in fluid communication with the emulsion inlet.

7. The microfluidic device of claim 1, wherein the at least one membrane is a nanoporous membrane.

8. The microfluidic device of claim 7, wherein the nanoporous membrane is selected from the group consisting of an ion track-etched nanoporous polycarbonate membrane and a silicon-on-insulator nanopore array.

9. The microfluidic device of claim 5, wherein the at least one membrane is configured to deflect the plurality of water-in-oil emulsion droplets and to transfer the water-in-oil droplets from the emulsion to the liquid in the flow junction.

10. The microfluidic device of claim 5, wherein the plurality of water-in-oil emulsion droplets are stabilized by one or more surfactants.

11. The microfluidic device of claim 4, wherein the liquid is a laminar flow of an aqueous phase that pushes the emulsion into contact with the at least one membrane.

12. A method of for producing vesicles with a microfluidic device having a microfluidic channel embedded in a substrate comprising
supplying an emulsion flow comprising a plurality of emulsion droplets into a first fluid inlet of the microfluidic channel;
supplying a liquid flow into a second fluid inlet of the microfluidic channel;
combining the emulsion flow with the liquid flow in a flow junction to form a combined fluid flow, the combined fluid flow traveling orthogonal to the plane of the substrate; and
using a membrane disposed in the flow junction, transferring the plurality of emulsion droplets from the emulsion flow to the liquid flow resulting in vesicles.

13. The method of claim 12, further comprising deflecting the vesicles with the membrane into a vesicle outlet.

14. The method of claim 12, further comprising, before the supplying steps, generating an emulsion.

15. The method of claim 14, wherein the generating step is accomplished by at least one droplet maker in fluid communication with the microfluidic channel.

16. The method of claim 15, wherein the generating step is accomplished by a plurality of droplet markers in fluid communication with the microfluidic device.

17. The method of claim 12, wherein the emulsion flow is a water-in-oil emulsion.

18. The method of claim 17, wherein the water-in-oil emulsion is stabilized by one or more surfactants.

19. The method of claim 12, wherein the membrane is a nanoporous membrane selected from the group consisting of an ion track-etched nanoporous polycarbonate membrane and a silicon-on-insulator nanopore array.

20. The method of claim 12, wherein the liquid flow is a laminar flow of an aqueous phase that directs the emulsion flow into contact with the membrane.

21. The method of claim 12, wherein the substrate comprises stacked polymer layers which define the microfluidic channel.

22. A plurality of vesicles obtained according to the method of claim 12.

23. A method of producing vesicles having a tunable inner leaflet and a tunable outer leaflet comprising
supplying a first emulsion flow including a plurality of emulsion droplets and a first surfactant into a first fluid inlet of a microfluidic channel of a microfluidic device embedded in a substrate;
supplying an oil flow including a second surfactant into a second fluid inlet of the microfluidic channel;
combining the first emulsion flow with the oil flow in a first flow junction to form a first combined fluid flow, the combined fluid flow traveling orthogonal to the plane of the substrate;
using a membrane disposed in the first flow junction, transferring the plurality of emulsion droplets from the first emulsion flow to the oil flow resulting in second emulsion flow;
supplying an aqueous phase flow into a third fluid inlet of the microfluidic channel;
combining the second emulsion flow with the aqueous phase flow in a second flow junction to form a second combined fluid flow, the second combined fluid flow traveling orthogonal to the plane of the substrate; and
using a membrane disposed in the second flow junction, transferring the plurality of emulsion droplets from the second emulsion flow to the aqueous phase flow resulting in vesicles.

24. The method of claim 23, wherein the first surfactant and the second surfactant are different.

25. A plurality of vesicles obtained according to the method of claim 23.
